(19) United States
(12) Patent Application Publication
(10) Pub. No.: US 2005/0039007 A1
(43) Pub. Date: Feb. 17, 2005

(54) Multi-function product profile downloading after authentication

(76) Inventors: Keith Hoene, Boise, ID (US); Robert Sesek, Meridian, ID (US); Craig Korfanta, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/640,158

(22) Filed: Aug. 13, 2003

(51) Int. Cl. H04L 9/00

(52) U.S. Cl. 713/170

(57) ABSTRACT

This invention relates to a system, that upon a user being authenticated on a device, such as a multi-function product or a digital sender, a profile that contains the user's most used settings and functions can be downloaded to the product. These settings would become the product's defaults until the user logs off of the device.

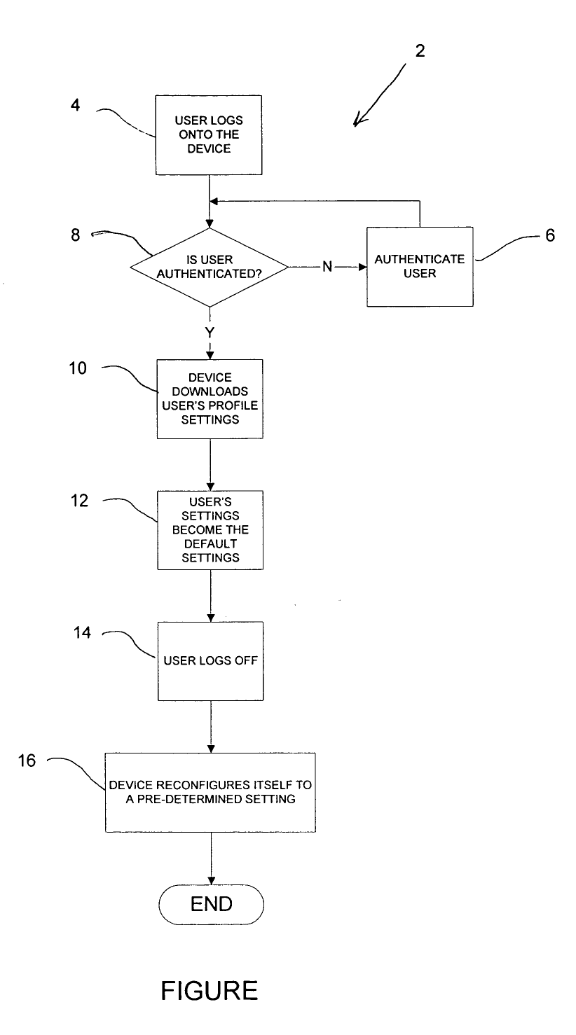

### BACKGROUND OF THE INVENTION

1. Field of the Invention

This invention relates to a system, that upon a user being authenticated on a device, such as a multi-function product or a digital sender, a profile that contains the user's most used settings and functions can be downloaded to the product. These settings would become the product's default settings until the user log off of the device.

2. Description of the Related Art

Prior to the present invention, as set forth in general terms above and more specifically below, it is known, for the user to log on and use the system interface, as it was designed, and navigate the device and network using input devices not designed very well for those functions.

It is also known to employ a system that modifies the network configuration. These prior art systems establish a connection between the device and the server and allow the network to reset itself up. However, this system includes a zero-configuration, which does not allow the user to configure the device. Also, these systems modify the network configuration that is not desirable in the present invention.

Finally, it is known to employ a system that provides security for a location in a network. These prior art systems are concerned with providing a profile that allows the digital certificate to be more user-friendly. However, this system also does not allow the user to configure the device. Therefore, a more advantageous system, then, will be provided if the system would allow the user to configure the device.

It is apparent from the above that there exists a need in the art for a system, that upon a user being authenticated on a multifunctional product or a digital sender, a profile that contains the user's most used settings and functions can be downloaded to the product. These settings would become the product's defaults until the user logs off of the device. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a method for user profile downloading after authentication, wherein the method is comprised of the steps of: logging a user into a device; determining if the user is authenticated to use the device; downloading a profile of the user's settings into the device; using the settings' profile as a default setting for the device; and logging the user off of the device, such that the device returns to a pre-configured device setting.

In certain preferred embodiments, the device can be, but is not limited to, a multi-function product and/or a digital sender. In another further preferred embodiment, the user-specific profiles could be configured off-line by either the user or a system administrator and saved until the user logs onto and is authenticated by the device.

The preferred user profile downloading system, according to various embodiments of the present invention, offers the following advantages: ease-of-use, increased user efficiency, pre-configuration of user settings; and good economy. In fact, in many of the preferred embodiments, these factors of ease-of-use, increased user efficiency, and pre-configuration of user settings are optimized to an extent that is considerably higher than heretofore achieved in prior, known user profile downloading systems.

The above and other features of the present invention, which will become more apparent as the description proceeds, are best understood by considering the following detailed description, in conjunction with the FIGURE.

### BRIEF DESCRIPTION OF THE DRAWING

The FIGURE is a flowchart of a method for user profile downloading after authentication, according to one embodiment of the present invention.

### DETAILED DESCRIPTION OF THE INVENTION

With reference to the FIGURE, there is illustrated one preferred embodiment for use of the concepts of this invention. Method 2 for downloading a user profile after authentication is illustrated. Method 2 includes, in part, the steps of: having the user log onto the device (step 4); authenticating the user (step 6); determining if the user is authenticated to use the device (step 8); downloading the user's profile's settings into the device (step 10); allowing the user's profile's settings to become the default settings of the device (step 12); having the user log off of the device (step 14); and reconfiguring the device settings to predetermined default settings.

With respect to step 4, it is to be understood that the device can be, but is not limited to, a multi-function product (MFP) and/or a digital sender. With respect to steps 6 and 8, the user can be authenticated to use the device, according to any number of commonly acceptable authentication methods.

With respect to steps 10 and 12, the user's specific profile settings could be configured off-line by either the user or a system administrator. For example, this process might involve pre-configured templates to speed up the process. The administrator can be given “type” options to be available for certain logons, such as certain send options are not available for standard logon like sending to the entire enterprise.

With respect to the settings, the device could set the send location, provide the user with one or more locations and/or preconfigured Public Distribution Lists (PDLs), send file characteristics, or even download the user's private address book. The default send location could be enhanced by downloading a localized list consisting of a subset of the entire enterprise locations. This list would comprise the user's most commonly used e-mail addresses and network locations to allow for quick selection by easily using the up-and-down scroll keys located on the user interface (Ul) (not shown) of the device.

In addition to digital send settings, the user profile could also set copy settings to commonly used options such as 2-sided or two pages per sheet or stapling settings. More than just setting default values, the user selections from the various device menus could be rearranged so that their commonly used functions are readily available at the first level of menu selection.

The profile settings could be controlled manually by the user, and changed only when the user explicitly saves them, or they can be automatically updated based on the last used user settings or an “average” of the most commonly used settings. The user could toggle between default and one or more custom views in order to find features more easily or features removed from the custom view presented upon authentication. In this manner, the system administrator could create a job accounting function by tracking the percentage of features used across all users. With respect to steps 14 and 16, after the user has logged off of the device, the device reconfigures its settings to those pre-configured device settings that were in use prior to the user logging onto and being authenticated by the device.

It is to be understood that the flowchart of the FIGURE shows the architecture, functionality, and operation of one implementation of the present invention. If embodied in software, each block may represent a module, segment, or portion of code that comprises one or more executable instructions to implement the specified logical functions. If embodied in hardware, each block may represent a circuit or a number of interconnected circuits to implement the specified logical function(s).

Also, the present invention can be embodied in any computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “computer-readable medium” can be any means that can store, communicate, propagate or transport a program for use by or in connection with the instruction-execution system, apparatus or device. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc. It is to be understood that the computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiments of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Although the flowchart of the FIGURE shows a specific order of execution, the order of execution may differ from that which is depicted. For example, the order of execution of two or more blocks may be scrambled relative to the order shown. Also, two or more blocks shown in succession in the FIGURE may be executed concurrently or with partial concurrence. All such variations are within the scope of the present invention.

An illustrative example of the concepts of the present invention will now be provided. Suppose, for example, that there exists a secure room in an office building that contains highly sensitive documents. There is also a multi-function product located in the secure room that can be used to scan, fax, copy and/or print documents that are located in the secure room. However, due to the sensitive nature of the documents, not everyone having access to the secure room can have access to use all of the features of the multi-function product. For example, the system administrator may set up the user authentication codes so that only individuals with a certain level of security clearance can use all of the features of the multi-function product. Those individuals who do not have that level of security clearance would only be allowed to, for example, use the print feature of the multi-function product when they logged on and were authenticated by the multi-function product. After the individual with the lower level of security clearance was finished using the multi-function product and had logged off of the device, the device would automatically reconfigure itself to a pre-determined profile setting. This feature of the multi-function product would allow the system administrator to keep those individuals who do not have the proper security clearance from scanning, faxing and/or copying the sensitive documents.

Once given the above disclosure, many other features, modifications or improvements will become apparent to the skilled artisan. Such features, modification or improvements are, therefore, considered to be a part of this invention, the scope of which is to be determined by the following claims.

1. A method for user profile downloading after authentication, comprising the steps of:
logging a user onto a device;
determining if the user is authenticated to use the device;
downloading a profile of the user's settings into the device;
using the settings' profile as a default setting for the device; and
logging the user off of the device, such that the device returns to a pre-configured device setting.

2. The method, as in claim 1, wherein said method is further comprised of the step of:
configuring said user profile.

3. The method, as in claim 2, wherein said configuring step is further comprised of the step of:
using preconfigured templates.

4. The method, as in claim 1, wherein said step of using the settings profile as the default setting for the device is further comprised of the steps of:
allowing the user to manually select a profile setting; and
storing said manually selected profile setting in said user's profile.

5. The method, as in claim 1, wherein said step of using the settings profile as the default setting for the device is further comprised of the step of:
automatically updating said user's profile based upon the last used user settings.

6. The method, as in claim 1, wherein said step of using the settings profile as the default setting for the device is further comprised of the step of:
automatically updating said user's profile based upon an average of the most commonly used user settings.

7. A system for user profile downloading after authentication, comprising of:
logging means for logging a user onto a device;
determining means for determining if the user is authenticated to use the device;
downloading means for downloading a profile of the user's settings into the device;
means for using the settings' profile as a default setting for the device; and
logging means for logging the user off of the device, such that the device returns to a pre-configured device setting.

8. The system, as in claim 7, wherein said system is further comprised of:
configuring means for configuring said user profile.

9. The system, as in claim 8, wherein said configuring means is further comprised of:
means for using preconfigured templates.

10. The system, as in claim 7, wherein said means for using the settings' profile as the default setting for the device is further comprised of:
means for allowing the user to manually select a profile setting; and
storing means for storing said manually selected profile setting in said user's profile.

11. The system, as in claim 7, wherein said means for using the settings' profile as the default setting for the device is further comprised of:
means for automatically updating said user's profile based upon the last used user settings.

12. The system, as in claim 7, wherein said means for using the settings' profile as the default setting for the device is further comprised of:
means for automatically updating said user's profile based upon an average of the most commonly used user settings.

13. A program storage medium readable by computer, tangibly embodying a program of instructions executable by the computer to perform method steps for user profile downloading after authentication, comprising the steps of:
logging a user onto a device;
determining if the user is authenticated to use the device;
downloading a profile of the user's settings into the device;
using the settings' profile as a default setting for the device; and
logging the user off of the device, such that the device returns to a pre-configured device setting.

14. The medium, as in claim 13, wherein said method is further comprised of the step of:
configuring said user profile.

15. The medium, as in claim 14, wherein said configuring step is further comprised of the step of:
using preconfigured templates.

16. The medium, as in claim 13, wherein said step of using the settings' profile as the default setting for the device is further comprised of the steps of:
allowing the user to manually select a profile setting; and
storing said manually selected profile setting in said user's profile.

17. The medium, as in claim 13, wherein said step of using the settings' profile as the default setting for the device is further comprised of the step of:
automatically updating said user's profile based upon the last used user settings.

18. The medium, as in claim 13, wherein said step of using the settings' profile as the default setting for the device is further comprised of the step of:
automatically updating said user's profile based upon an average of the most commonly used user settings.
